(19) United States
(12) Patent Application Publication
(10) Pub. No.: US 2006/0243594 A1
(43) Pub. Date: Nov. 2, 2006

(54) Impedance measurement in a fluidic microsystem

(76) Inventors: Thomas Schnelle, Berlin (DE); Torsten Mueller, Berlin (DE); Stephen Shirley, Warks (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/523,175

(22) PCT Filed: Jul. 28, 2003
(86) PCT No.: PCT/EP03/08312

§ 371 Date: Feb. 24, 2006

(30) Foreign Application Priority Data
Jul. 29, 2002 (DE) 102 34 487.6

(51) Int. Cl. B03C 5/02

(52) U.S. Cl. 204/547; 204/643

(57) ABSTRACT

Described are a method and a measuring device for measuring the impedance in a fluidic microsystem comprising a compartment (10) through which a liquid comprising at least one suspended particle (16) flows, and in which at least one impedance detector (40) is arranged, by means of which for detection of the at least one particle at least one impedance value is acquired which is characteristic for the impedance of the compartment, and which in the presence of the at least one particle changes in a predetermined way, wherein focusing of the at least one particle takes place in a predetermined space relative to the impedance detector, wherein focusing involves a movement of the at least one particle relative to the fluid flowing in the compartment as a result of dielectrophoretic forces, which forces are exerted by means of at least two focusing electrodes (30).

The invention relates to methods for measuring the impedance in a fluidic microsystem, in particular to methods for particle detection in fluidic microsystems by way of impedance measuring, and to measuring devices for implementing such methods.

The counting of biological cells according to the so-called Coulter-counter principle is well known. According to this principle, cells are moved through a small aperture between two spaces in which two electrodes are arranged. When the electrical resistance between the electrodes changes, a cell is detected in the aperture and is counted. This principle was first developed for macroscopic fluidic systems (typical line dimensions in the mm to cm range) and is increasingly also applied in fluidic Microsystems (WO 00/37628, S. Gawad et al. in “IEEE-EMBS Conference on Microtechnologies in Med. & Biol.”, 2000, Lyons, France, and M. Koch et al. in “J. Micromech. Microeng.”, vol. 9, 1999, pages 159-161).

For example, WO 00/37628 describes a microsystem for cell permeation (or cell fusion) in which cell detection with the use of electrical resistance measuring takes place prior to permeation. For size-dependent cell permeation, the particles, under the effect of negative dielectrophoresis, are transferred to various partial channels of the microsystem, depending on particle size. In each partial channel, the particles together with the flowing liquid are moved past a pair of electrodes at which resistance measuring takes place. The detection technique according to WO 00/37628 is associated with an disadvantage in that the particles are not aligned in relation to the respective pair of electrodes. There are no provisions for focusing. The reproducibility of the detector signals is thus diminished, with detection being unreliable.

Gawad et al. also use planar impedance sensors or pairs of electrodes on opposite walls of a compartment of the microsystem. For alignment relative to the sensors, the cells are conveyed through a nozzle (e.g. channel with a diameter of 20 μm·20 μm) in order to obtain an impedance signal which can be evaluated well. For the signal-to-noise ratio of the impedance method essentially depends on the ratio of the cell radius to the channel cross section on a detector electrode (see Koch et al.). However, this arrangement is associated with a disadvantage in that narrow nozzles or channels bring about an increased danger of blockages occurring. Moreover they reduce the cell throughput.

Furthermore, it has been known to carry out impedance measuring in fluidic Microsystems with the use of a reference electrode system (s. Gawad et al.) Impedance measuring usually takes place in at least one fixed frequency in the range from approximately 10 kHz to MHz. By using several frequencies, additional information about the detected cells can be obtained. In single cell impedance spectroscopy, impedance measuring takes place in relation to a particular frequency spectrum (s. H. G. L. Coster et al. in “BioElectroChem. BioEnerg.” vol. 40, 1996, pages 79-98).

The danger of blockages can be avoided if hydrodynamic focusing is provided instead of a nozzle. However, hydrodynamic focusing provides a principle disadvantage in that as a rule measuring electrodes are affixed to a channel wall, while focusing in the margin area is either impossible or only possible with very considerable technical expenditure. Moreover, hydrodynamic focusing can only be used to a limited extent. It is in particular made difficult as a result of the system geometry (short length of the channel) or low pumping rates. Furthermore, focusing results in hydrodynamic stress which is undesirable in particular in the case of sensitive biological cells.

Other detection principles are also known which are either implemented independently or in combination with impedance measuring. For example, optical methods are based on measuring the light scatter of the particles to be detected. However, this requires the use of a particular geometry and transparent wall materials in the microsystem. In magnetic focusing, cells are made to approach measuring electrodes with the use of external magnetic fields. To this effect, magnetic particles have to be coupled to the cells, which magnetic particles are however disadvantageous for impedance-spectroscopy measurements. Thermal focusing using local heaters is also disadvantageous because the cells are exposed to undesirable temperature changes.

It is the object of the invention to provide improved methods for impedance measuring in fluidic microsystems, with which the disadvantages of conventional detection methods can be overcome, and which methods in particular allow improved focusing of particles near detector electrodes. It is also an object of the invention to further improve impedance measuring in fluidic microsystems such that particles are not only counted, but that further information on the particles is also obtained. It is a further object of the invention to provide improved measuring devices for measuring the impedance in fluidic microsystems.

These objects are met with methods and measuring devices with the features according to claim 1 or 14. Advantageous embodiments and applications of the invention are defined in the dependent claims.

It is a basic idea of the invention to focus, near the impedance detector, suspended particles which are to be detected by means of at least one impedance detector in a compartment of a fluidic microsystem under the effect of dielectrophoretic field forces which act in the compartment. By means of at least two focusing electrodes, high-frequency electrical fields are generated under whose effect by means of negative dielectrophoresis the particles are moved relative to a fluid flow in the compartment into part of the flow and in this way are positioned in a predetermined way relative to the impedance detector. In the compartment, the particles are moved along a predetermined trajectory, defined by dielectrophoretic focusing, past the impedance detector. By way of the combination, according to the invention, of the impedance detector with the focusing electrodes, of which there are at least two, the disadvantages of conventional focusing techniques are overcome in an advantageous way. In particular, undesirable strains as a result of mechanical or hydrodynamic forces are avoided. Furthermore, dielectrophoretic focusing can be optimally matched to the respective particles to be detected.

According to the invention, measuring the impedance takes place with at least one impedance detector which is arranged in a compartment of the microsystem through which compartment a fluid flows. Generally speaking, the compartment is a line structure in the microsystem, such as e.g. a channel or a reservoir through which the fluid flows. Typical cross-sectional dimensions of the compartment range for example from 200 μm to 800 μm (width), and 20 μm to 100 μm (height). The compartment is made in a chip body made of a solid material (e.g. semiconductor, ceramic material, plastic material or the like). The impedance detector, of which there is at least one, comprises at least two detector electrodes which are affixed to one or several walls of the compartment. The dielectrophoretic focusing, according to the invention, of particles generally involves movement of particles into a part of the flow (flow segment), in that particles, when they move past the impedance detector, maintain a predefined distance, preferably a reduced distance, from one of the detector electrodes.

According to the invention, focusing can take place upstream in relation to the impedance detector. This embodiment can be advantageous because of the separate control of focusing- and detector electrodes. As an alternative, focusing can take place on the impedance detector. This may result in advantages as a result of a simplified electrode design.

According to a first advantageous embodiment of the invention, dielectrophoretic focusing involves movement into a part of the flow (e.g. into the middle of the flow), which part is located on a connection line between two detector electrodes arranged on opposite walls of the compartment or in whose vertical projection on a wall of the compartment at least one detector electrode is arranged. This movement is associated with an advantage in that all the particles move past the detector electrode, of which there is at least one, in a predetermined window through a field barrier which is nozzle-shaped or funnel-shaped. In a way different to that used in conventional techniques, the passage through the window does not involve any touching of mechanical fixed components nor any focusing flow forces. In this way, advantageously an improvement of the signal-to-noise ratio (SNR) is achieved. A laterally offset passage past the detector electrode is avoided. As an alternative or in addition, dielectrophoretic focusing can comprise movement of particles such that perpendicular distance of a particle moving past at least one of the detector electrodes is reduced. In this case, the perpendicular distance of the particle passage on the detector electrode is set in a predetermined way.

According to the invention, particle focusing takes place with the use of at least two focusing electrodes which are arranged on a wall, e.g. the bottom of the compartment. With two electrodes, the particles can be displaced towards the opposite wall of the compartments near the detector. This can be advantageous if e.g. for impedance spectroscopy a longer measuring time (or a slower flow speed) is desired, as is the case on the edge of the flow.

As an alternative, three focusing electrodes can be used, two of which are arranged so as to converge on a wall of the compartment, e.g. to form a funnel-shaped field barrier. The third electrode is arranged as a counter electrode on the opposite wall of the compartment. This embodiment can be of advantage since three-dimensional focusing in the compartment is achieved with a relatively small number of electrodes.

However, in a particularly preferred way, the invention is implemented with two pairs of focusing electrodes which are arranged on opposite faces of the compartment (e.g. bottom, top). Each pair of focusing electrodes comprises two focusing electrodes, e.g. in the shape of converging electrode strips. The use of two focusing electrode pairs can be advantageous for setting predetermined trajectories by means of a funnel-shaped field barrier.

According to a further embodiment of the invention, the at least one measured impedance value is evaluated not only in relation to the presence of a particle, but also in relation to the dielectric characteristics of the particle respectively detected. Advantageously, in this way additional information on the flowing particle, e.g. information relating to the vitality state of a cell or the like, can be obtained.

According to a further advantageous embodiment of the invention, with the use of at least one impedance detector a multitude of impedance values are acquired and their time behaviour in relation to the point in time, the direction and/or the speed of at least one particle passing the impedance detector is evaluated. In this way, advantageously the scope of application of conventional impedance particle counting is expanded to the detection of further characteristics of the particles or of the microsystem. To this effect, preferably an asymmetrical electrode shape is implemented which is generally characterised in that the electrode shape in one direction parallel to the direction of passage or fluid flow, is not mirror-symmetrical in relation to axes perpendicular to the direction of passage or fluid flow.

If an impedance detector with a single detector electrode pair is used, which pair is characterised by an asymmetrical electrode shape in relation to the direction of the fluid flow, then in a simplified design the option arises of deriving the above-mentioned measured quantities from the time behaviour of impedance values. If several impedance detectors are used which are spaced apart from each other, there is no need for asymmetrical electrode shapes.

A preferred embodiment of the invention provides for the detection of impedance values using an impedance detector with detector electrodes, wherein the shape of at least one of the detector electrodes in a direction parallel to the direction of the fluid flow changes, and/or the detector electrodes are arranged on opposite sides of the compartment and comprise various shapes. In this way it is possible with only a single impedance detector to detect and evaluate time-dependence of the impedance change during the passing of particles.

Another subject of the invention is a measuring device for measuring the impedance in a fluidic microsystem comprising at least one impedance detector which is arranged in a compartment of the microsystem, through which compartment fluid flows, and comprising at least one focusing device which has at least two focusing electrodes for exerting dielectrophoretic forces on suspended particles which flow through the compartment. The provision of the focusing electrodes, of which there are at least two, makes it possible to form a funnel-shaped field barrier for particle focusing and provides the advantage of optimal integratability of the measuring device according to the invention into fluidic microsystems which are known per se, based on fluidic chips.

According to an advantageous embodiment of the measuring device, the focusing device comprises at least two pairs of focusing electrodes which in the compartment form the funnel-shaped field barrier. A field barrier is formed by a distribution of high-frequency fields which emanate from the focusing electrodes and exert dielectrophoretic repellent forces on the particles. A funnel-shaped field barrier is characterised by a field distribution which, apart from a field minimum (e.g. in the middle of the compartment), forms repellent forces so that particles cannot pass with the fluid flow but are forced to flow through the field minimum. With the funnel-shaped field barrier, the particles can advantageously pass the impedance detector at a predetermined position.

In each instance, the impedance detector comprises at least two detector electrodes which are preferably affixed in a planar shape to a wall or to various, e.g. opposite, walls of the compartment. If one of the planar detector electrodes is of non-uniform shape relative to the direction of the fluid flow, and if a time sequence of impedance values is recorded, the impedance detector provides additional information on the detected particles or on the microsystem. The design of the detector electrodes is determined by their external shape or by structuring. The outer shape comprises, for example, triangular, oval, rectangular or circular shapes or shapes composed of these. By way of structuring, for example, an electrode breakthrough or a passivation layer on the electrode is provided. As an alternative to the above, the shape of the impedance detector per se can be non-uniform or asymmetrical in the direction of the fluid flow, in that the detector electrodes are of different shape or offset in relation to each other. In this design too, the change in capacity between the detector electrodes when a particle passes has a characteristic time dependence which in the measured impedance value supplies the additional information, e.g. about the direction of the fluid flow.

If the electrode structure is formed by at least one detector electrode, into whose surface a partial electrode is integrated, advantageously, measuring can take place at a particularly high sensitivity. In this arrangement, the partial electrode preferably is of a characteristic size which is equal to or smaller than the size of the perpendicular projection of the passing particle on the detector electrode with the partial electrode.

A particularly simple design of the impedance detector results if the impedance detector comprises at least two detector electrodes which are arranged on at least one wall of the compartment and which extend across the width of the compartment across the direction of the fluid flow. In this arrangement, the detector electrodes are preferably formed by straight electrode strips which are arranged one on top of the other, parallel to the direction of the fluid flow, on the walls of the compartment, wherein said detector electrodes comprise electrode strips of different widths and/or structured edges, wherein the structured edges are arranged so as to be offset across the direction of the fluid flow.

The invention provides the following advantages. The dielectrophoretic focusing is particularly gentle when used for cell detection. Focusing can easily be changed if the particle type or operating conditions change. The measuring device can be produced using processing techniques which are known per se as a part of known fluidic chips.

Further details and advantages of the invention are provided in the following description of the enclosed drawings. The following are shown:

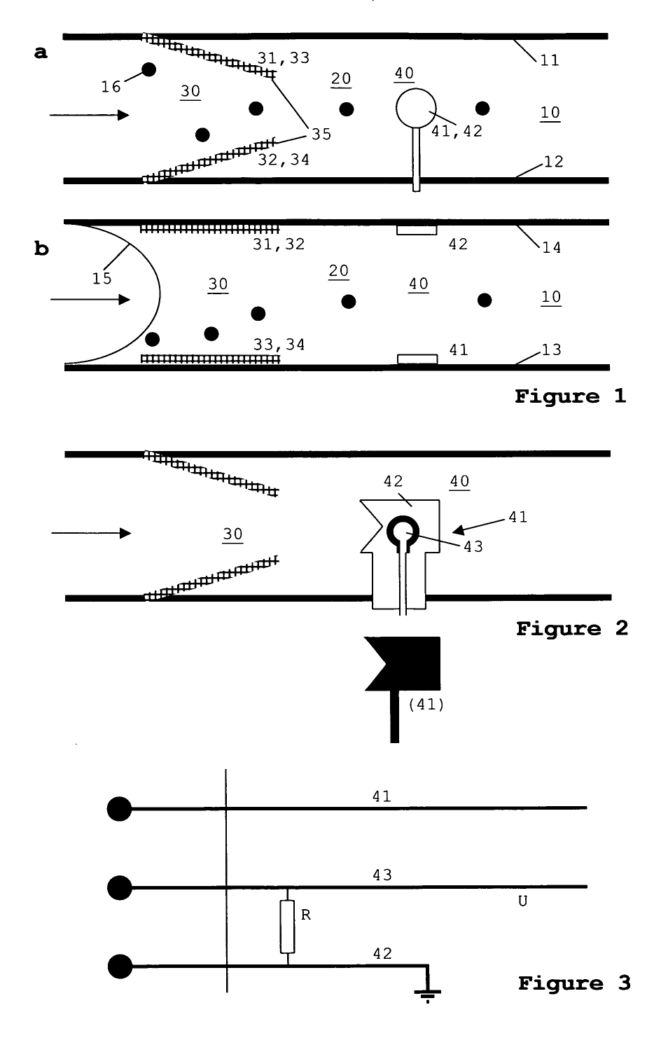

FIGS. 1 to 4: various embodiments of measuring devices according to the invention;

FIG. 5: various embodiments of focusing electrodes used according to the invention;

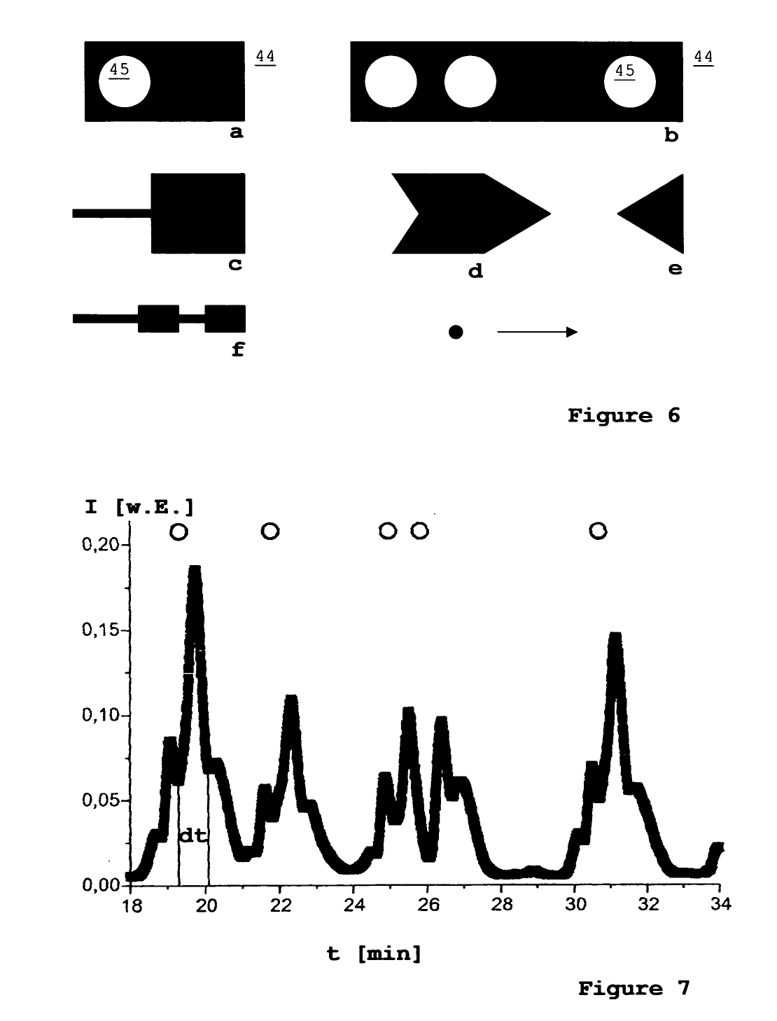

FIG. 6: various embodiments of detector electrodes used according to the invention;

FIG. 7: a graph of an experimentally determined impedance gradient; and

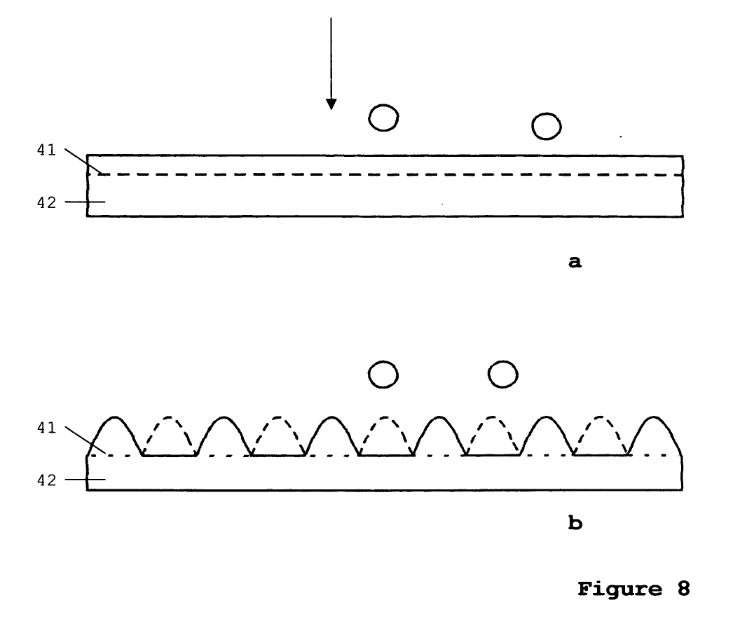

FIG. 8: further embodiments of detector electrodes used according to the invention.

FIGS. 1 to 4 illustrate various embodiments of combinations according to the invention, comprising focusing devices and impedance detectors, wherein each of which is arranged in a channel of a fluidic microsystem. Fluidic microsystems, in particular for manipulating biological cells, are known per se and are thus not described in detail in this document.

FIG. 1 is a diagrammatic top view (a) and a lateral view (b) of a channel 10 of the microsystem. The channel 10 is limited by the side walls 11, 12, a bottom 13 and a cover 14. The distance between the lateral surfaces 11, 12 preferably ranges from 100 μm to 1 mm, for example from 200 to 800 μm (width of the channel), while the spacing between the bottom 13 and the cover 14 is preferably approximately 5 μm to 200 μm, e.g. 20 to 100 μm (height of the channel). A fluid flows through the channel 10 in the direction of the arrow. Typically, the fluid flow is a laminar flow with the illustrated speed profile 15 and with a flow speed ranging from e.g. 20 μm/s to 20 mm/s. In the fluid flow, particles 16 are suspended which are to be detected using the method according to the invention. The particles 16 move in the direction of the fluid flow at the same speed as the fluid. Before focusing according to the invention takes place, the particles are at rest relative to the fluid.

The particles 16 comprise, for example, synthetic particles (e.g. plastic beads) or biological cells or cell components or biologically relevant organic macromolecules.

In the channel (or compartment) 10, a measuring device 20 according to the invention is provided which comprises a dielectrophoretic focusing device 30 and an impedance detector 40. The focusing device 30 is arranged upstream relative to the impedance detector 40. Between the focusing device 30 and the impedance detector 40, the side walls of the channel are continuous without lateral apertures.

The focusing device 30 comprises at least two focusing electrodes 31, 32. In the example shown, two pairs of focusing electrodes 31-34 are provided of which the first pair 31, 32 is, for example, arranged on the cover 14 and the second pair 33, 34 on the bottom 13. Each focusing electrode comprises a straight electrode strip which, on the cover 14 or on the bottom 13, extends from the edge of the channel towards the middle of the channel. The ends 35 of the focusing electrodes are spaced apart. By way of a connection line (not shown), the focusing electrodes are connected to a control device (with a high-frequency voltage source).

In the direction of the fluid flow, the impedance detector 40 is preferably arranged so as to be spaced apart from the focusing device 30 at a range of 10 μm to 2 mm. The impedance detector comprises at least two detector electrodes 41, 42, which are arranged on the bottom 13 and on the cover 14 of the channel 10. Each detector electrode 41, 42 can be designed per se as known from conventional impedance measuring in electrolytes. Preferably, said detector electrodes 41, 42 comprise a planar electrode surface of an asymmetrical or non-uniform shape (see below).

The particles 16 generally flow through the channel 10 in no particular order until they reach the focusing device 30. At this point the focusing electrodes 31-34, to which a voltage is applied evenly, form a funnel-shaped field barrier which narrows in the direction of the fluid flow. The ends 35 of the focusing electrodes 31-34 span a quadrangle in which there is a field minimum through which the particles 16 can pass. Subsequently, the particles 16 are arranged in line in a part of the flow according to the field minimum, e.g. in the middle of the channel. In this line-up the particles pass the detector electrodes 41, 42. On them, impedance measuring takes place according to principles known per se.

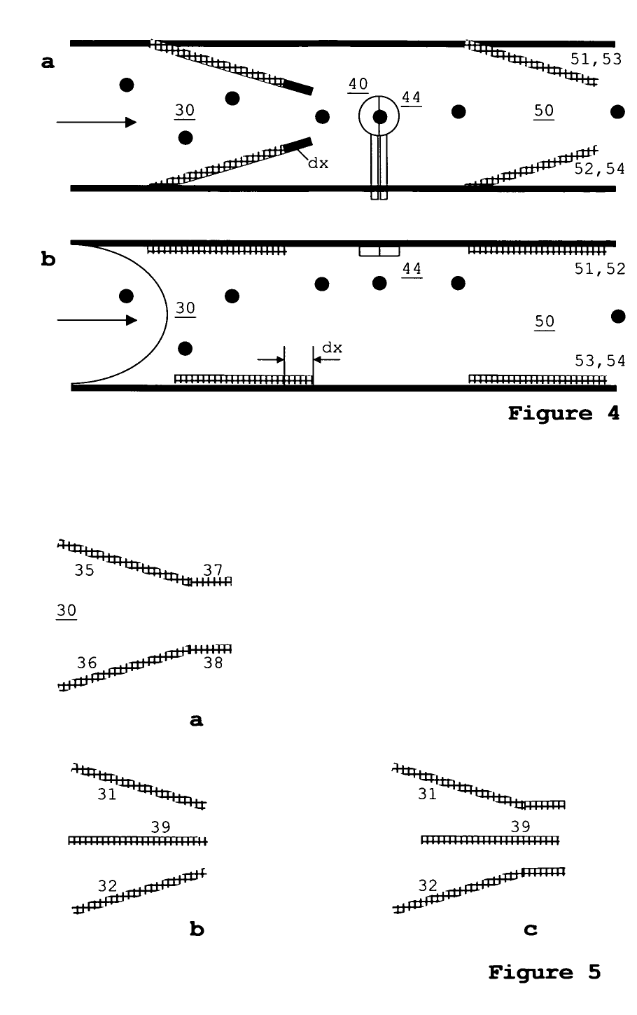

In the design according to FIG. 1, by means of symmetrical focusing electrodes 31-34, focusing takes place in the middle of the channel both in horizontal direction, i.e. in the middle between the lateral surfaces 11, 12, and in vertical direction, i.e. in the middle between the bottom 13 and the cover 14. It is not absolutely essential to always focus in vertical and horizontal direction. It is not mandatory for the particles 16 to be aligned so as to be focused in the middle of the channel. Generally speaking, the part of the flow in which the particles 16 are lined up in vertical projection to the bottom and covers is aligned with the detector electrodes 41, 42. In vertical direction, focusing results from the equilibrium between electrical field forces and the weight. If the electrical field forces and the weights exert an even action, the particles 16 are aligned in the equilibrium in the middle between the bottoms and the covers 13, 14. As an alternative, other equilibrium positions can be set, in particular through the shape and/or height of the field barrier, which field barrier is formed by the focusing electrodes 31-34 (see also FIG. 4).

Focusing and detection take place with the use of high-frequency voltages. The fact that any interfering mutual influencing of focusing and detection can be avoided forms part of the important and unexpected findings of the inventors. To this effect, focusing of the particle, of which there is at least one, and measuring the impedance value, of which there is at least one, take place at various frequencies. For example, various (separate) frequency ranges are used. Focusing that is gentle on the cells can be achieved by using a focusing frequency above several 100 kHz. This range is to be excluded for impedance measuring. Impedance measuring preferably takes place at a frequency below for example 100 kHz. As an alternative, impedance measuring can take place at higher frequencies (e.g. 1 MHz) in order to obtain information about the interior of the particles, e.g. the electrolyte content in cells. Accordingly, focusing electrodes would be operated at even higher or if appropriate at lower frequencies. As an alternative, or for providing further decoupling between focusing and detection, the impedance detector 40 can comprise a frequency filter, e.g. a low-pass filter or band-pass filter. With the frequency filter, those frequencies at which the focusing electrodes are operated are excluded from detection.

The interaction between the focusing device 30 and the impedance detector 40 can also be reduced by increasing the mutual spacing in the direction of the fluid flow. Preferably, the spacing is approximately 10 μm to 2 mm. Advantageously this is possible as a result of the laminarity of the flow in the channel 10. The distance can, for example, also be increased to up to 3 mm.

According to the top view in FIG. 2, the impedance detector 40 can comprise several different detector electrodes 41, 42 and 43. On the bottom and cover 13, 14 a detector electrode pair is provided which comprises two detector electrodes 41, 42 of relatively large surface areas. Both detector electrodes 41, 42 have the same external shape. The diagrammatic top view only shows the top electrode 42 fully. In the lower part of FIG. 2, for illustration purposes, the lower electrode 41 is shown. The upper detector electrode 42 includes a structure in that a third detector electrode 43 (partial electrode 43) is integrated in said upper detector electrode. Said third detector electrode 43 is arranged in a recess in the electrode surface of the upper electrode 42 at a distance from said upper electrode 42. Through the gap, part of the lower electrode 41 is visible. For example, the dimensions of the larger detector electrodes 41, 42 are around 120·150 μm, while the dimension of the individual smaller partial electrode 43 ranges e.g. from 2 to 20 μm, corresponding to the typical cell sizes in biology.

The three detector electrodes 41 to 43 according to FIG. 2 are preferably switched according to the principle illustrated in FIG. 3. A driver voltage of a predetermined measuring frequency (e.g. U<1 V, f=50 kHz) is applied to the lower detector electrode 41. The upper detector electrode 42 is on mass potential. Between the upper detector electrode 42 and the third detector electrode (partial electrode) 43, an electrical resistor R is arranged which is dimensioned according to the resistance of the liquid flowing through the compartment. The measuring voltage U is acquired on the third partial electrode 43 in relation to mass potential. Impedance measuring according to the invention takes place such that the voltage U is acquired continuously and the impedance is determined continuously. As soon as a particle is located above the third partial electrode 43, said electrode 43 is shielded so that the voltage U increases.

If the particle to be measured is led over the small partial electrode 43, there is thus a voltage difference between the electrodes 42 and 43. Advantageously, this measurement is particularly sensitive since with the partial electrode 43, as is the case with a virtual aperture, a measuring range of high local resolution and sensitivity is created. The partial electrode 43 should thus preferably not be significantly larger than the projection of the particle on the electrode plane. Furthermore, precise focusing with the focusing electrodes is advantageous. In combination with the funnel-shaped focusing electrodes it is thus possible to measure with enhanced accuracy and reproducibility the impedance and flow-through direction of the particle (see also FIG. 7).

The embodiment of the invention illustrated in FIGS. 2 and 3 provides an advantage in that it is possible to guide the particles with high accuracy over the small third electrode 43. As a result of dielectrophoretic focusing, instead of the conventional Coulter nozzle a “virtual” window is generated which is aligned precisely in relation to the third electrode 43. In this way, a particularly high signal-to-noise ratio can be achieved.

FIGS. 4a (top view) and 4b (lateral view) diagrammatically illustrate focusing in vertical direction. In this embodiment, the impedance detector 40 comprises a detector electrode pair 44 which is only arranged on the cover 14. The focusing device 30 comprises two pairs of focusing electrodes 31, 32 and 33, 34, of which the lower focusing electrodes 33, 34 are longer in the direction of the fluid flow by the distance dx than the upper focusing electrodes 31, 32. As a result of this, the field barrier is distorted, with the field minimum being shifted from the middle of the channel towards the cover 14 so that the particles 16 are focused in that part of the flow which is near the detector electrode pair 44. The shortest distance between the particles 16 and the detector electrode pair 44 is for example 1 μm.

The embodiment according to FIG. 4 with electrodes which are arranged offset in the direction of the fluid flow or which are of different length can provide an advantage in that the particles at unchanged (horizontal) focusing are led between the lateral surfaces closer to the electrode 44 in vertical direction, or according to FIG. 2 closer to the partial electrode 43, where they firstly travel at a slower speed and secondly display a higher impedance signal. This process can take place so as to be self-calibrating by way of backcoupling, so that advantageously the impedance signal can be optimised and maximised during the passage of particles by changing the amplitude of one of the electrode planes depending on the flow speed and/or the particle characteristics.

As an alternative or in addition to the offset arrangement of the electrodes, for the purpose of adjusting the vertical space between the particles and the electrodes of the impedance detector, it can be provided for the focusing electrodes to be operated with different strength of control (amplitude, frequency) of both electrode planes, and/or for the focusing electrodes to comprise different angles relative to the direction of the fluid flow.

According to the invention, the measuring device can additionally comprise a defocusing device 50 which is diagrammatically illustrated in the right section of FIGS. 4a and 4b. The function of the defocusing device 50 consists of redistributing the particles in the entire flow profile or of enriching the particles in the region of the highest flow speed after measuring has taken place. In this way, advantageously, the adhesion probability among particles (in particular of biological cells) can be reduced and the throughput can be increased. The defocusing device 50 comprises defocusing electrodes 51 to 54, which analogous to the above-mentioned principles cause the particles in the liquid to shift as a result of negative dielectrophoresis.

The focusing or defocusing electrodes of a measuring device according to the invention are preferably designed as electrode strips with an arrangement according to the desired field barrier. In a way that is different from the embodiments described above, the electrode strips can be curved in the respective wall plane (e.g. in the bottom plane), as illustrated in FIG. 5a. Two straight parallel electrode sections 37, 38 follow on from the converging electrode sections 35, 36. Providing straight parallel electrode sections on the ends of the focusing electrodes situated in the direction of the fluid flow can have advantages in relation to the effectiveness of the field barrier.

FIGS. 5b and 5c show focusing electrodes which comprise three partial electrodes. For example, according to FIG. 5b the focusing electrodes 31, 32 are arranged on the cover of a compartment, while the focusing counter electrode 39 is arranged on the bottom. Advantageously, with this arrangement three-dimensional focusing in the compartment can be achieved with the use of only three electrodes. The field barrier is, for example, generated by applying high-frequency alternating voltages with a respectively offset phase position. The phase is for example: 31: 0°, 32: 120°, 39: 240°, or 31: 0°, 32: 180°, 39: mass potential. The arrangement according to FIG. 5b can be modified with the focusing electrode shapes according to FIG. 5a (see FIG. 5c).

According to an alternative embodiment of the invention, the arrangement of focusing electrodes can at the same time be used as a detector device. To this effect, for the purpose of creating a funnel-shaped field barrier, the electrode strips are brought together in a convergent shape such that there is little distance between the electrode tips in the direction of the fluid flow, with said distance approximately corresponding to the channel height. For focusing, high-frequency voltages are applied to the focusing electrodes (e.g. according to FIG. 1). Impedance is measured diagonally, i.e. for example between the electrodes 31 and 34 or 32 and 33. In a design according to FIG. 5b or 5c, impedance measuring can take place between one of the electrodes 31, 32 and the counter electrode 39.

When a particle moves past an impedance detector, the measured impedance signal not only depends on the dielectric characteristics (in particular the dielectricity constant and the conductivity) of the particle and the suspension solution, but also on the volume fraction of the particle between the measuring electrodes. If the measuring electrodes are designed in a non-uniform or asymmetrical way relative to the direction of the fluid flow, as is for example illustrated in FIG. 6, when the particles pass at a constant flow speed an impedance signal with a non-uniform time behaviour is measured. The impedance signal is asymmetrical in relation to the maximum. From the graph, not only the flow speed, but also the direction of the fluid flow can be determined (see FIG. 7). For the provision of non-uniform or asymmetrical measuring electrodes, they are given a particular electrode shape and/or electrode structure. Electrode structuring involves for example breakthroughs or holes in the electrode surface. As an alternative it is also possible to provide passivation by way of passivation layers on the electrode surface. FIGS. 6a and 6b show examples of electrode surfaces 44 with circular breakthroughs 45 (or passivation layers). An asymmetrical electrode surface of an impedance detector is provided when the effective electrode surface changes in the direction of the fluid flow. In FIG. 6, this is provided for example by an alignment of the breakthroughs 45. As an alternative, the variation in the electrode surface according to FIGS. 6c to 6f can also be provided by changing the outer shape. The border of the electrode surface is characterised by at least one triangular, rectangular, oval or circular structure.

The measuring electrodes comprise an inert conductive material, in particular a metal, such as e.g. platinum or gold. The passivation layers comprise an insulating material, e.g. silicon oxide.

By way of an example, FIG. 7 shows the time behaviour of an impedance signal which was acquired with an asymmetrical impedance detector according to FIG. 2. The graph shows the impedance signal (arbitrary units) in a time-dependent context. The circles shown at the top designate instances of particles passing through, which instances were determined by video monitoring. In each instance of a particle passing through, the impedance graph shows a characteristic asymmetry relative to the respective maximum. On each side of a maximum a secondary lobe (shoulder) can be measured, of which the amplitude of the second shoulder in time is smaller than that of the first shoulder. From this, the direction of the fluid flow can be derived. Furthermore, from the distance dt between the minima between a shoulder and the maximum, the flow speed can be derived because dt corresponds to the transit time of the particles, and the size of the measuring electrode is known.

As an alternative to the asymmetrical electrode shape according to FIG. 2 or FIG. 6, the characteristics shown in FIG. 7 can also be recorded by a combination of several measuring methods spaced apart from each other in the direction of the fluid flow.

FIGS. 8a and b show embodiments of two impedance sensors which extend transversely to the direction of the fluid flow (see arrow) across the width of the entire channel. For example, the dashed-line electrode 42 is arranged at the top while the solid-line electrode 41 is arranged at the bottom on the covering and bottoms (see above) or vice versa (diagrammatically shown in an enlarged view). When particles, and in particular biological cells, pass through, these detectors generate an asymmetrical impedance signal by means of which the particles can be counted or which impedance signal makes it possible to determine the direction of passing through.

In the design according to FIG. 8, the signal-to-noise ratio may be less favourable than is the case with the individual sensors described above, but this can advantageously be compensated for with the use of a suitable resistance bridge measuring arrangement.

Impedance measuring according to the invention can be modified as follows. The focusing electrodes can be structured, as is known per se from microsystem technology for the provision of predetermined field barrier gradients. The focusing field barriers can also be modified in the focusing device by controlling the voltage and/or the phase of the high-frequency electrical fields.

1. (canceled)

2. The method according to claim 29, in which focusing takes place upstream relative to the impedance detector.

3. The method according to claim 29, in which focusing takes place directly on the impedance detector.

4. The method according to claim 29, in which focusing involves a movement of the particle in a part of the fluid flow in whose perpendicular projection onto a wall of the compartment the impedance detector is arranged.

5. The method according to claim 29, in which focusing involves a movement of the at least one particle such that the perpendicular distance between the particle and the impedance detector is reduced.

6. The method according to claim 29, in which synthetic or biological particles move past the impedance detector.

7. The method according to claim 29, in which the impedance value is evaluated in relation to dielectric characteristics of the respective passing particle.

8. The method according to claim 29, in which a multitude of impedance values is acquired whose time behaviour is evaluated in relation to at least one of the point in time, the direction and the speed of the particle moving past.

9. The method according to claim 8, in which from the time behaviour of the impedance values a flow speed of the fluid is acquired.

10. The method according to claim 8, in which the impedance values are acquired with the impedance detector, wherein respectively detected particles moves past detector electrodes of the impedance detector, wherein the shape of at least one of the detector electrodes changes in a direction parallel to the direction of the flow of the fluid.

11. The method according to claim 8, in which the impedance values are acquired with the impedance detector, wherein respectively detected particles moves past the detector electrodes of the impedance detector, which detector electrodes are arranged on opposite sides of the compartment and are of various shapes.

12. The method according to claim 8, in which the impedance values are acquired using the impedance detector and at least one further impedance detector which is arranged so as to be spaced apart in the direction of the fluid flow.

13. The method according to claim 29 in which focusing of the particle and measuring of the impedance value take place at different frequencies.

14. A measuring device for measuring the impedance in a fluidic microsystem, comprising:
an impedance detector which is arranged in a compartment of the microsystem through which a fluid flows; and
a focusing device whereby at least one particle is movable in close proximity to the impedance detector,
said focusing device comprising at least two focusing electrodes for exerting dielectrophoretic forces onto the at least one particle wherein the focusing device forms a funnel-shaped field barrier in the compartment.

15. The measuring device according to claim 14, in which the focusing device is arranged upstream relative to the impedance detector.

16. The measuring device according to claim 14, in which the impedance detector forms part of the focusing device.

17. The measuring device according to claim 14, in which at least two pairs of focusing electrodes are provided on opposite walls of the compartment, which electrodes form the funnel-shaped field barrier.

18. The measuring device according to claim 14, in which the lengths of the focusing electrodes differ in the direction of the fluid flow.

19. The measuring device according to claim 14, in which the impedance detector comprises at least two detector electrodes which are arranged on one wall or on various walls of the compartment.

20. The measuring device according to claim 19, in which at least one of the detector electrodes in a reference direction parallel to the direction of the fluid flow is non-uniform in shape or in which both detector electrodes in a reference direction parallel to the direction of the fluid flow differ in shape.

21. The measuring device according to claim 20, in which the detector electrode, of which there is at least one, is of a shape which comprises at least one of
at least one triangle;
at least one strip-surface combination; and
at least one electrode structure.

22. The measuring device according to claim 21, in which the at least one electrode structure comprises an electrode breakthrough or an electrode passivation layer.

23. The measuring device according to claim 21, in which the at least one electrode structure is formed by at least one detector electrode in whose surface a partial electrode is integrated.

24. The measuring device according to claim 23, in which the partial electrode is of a characteristic size, which essentially is equal to or smaller than the size of the vertical projection of the particle onto the plane of the detector electrode with the partial electrode.

25. The measuring device according to claim 14, in which the impedance detector comprises at least two detector electrodes which are arranged on at least one wall of the compartment, and extend across the width of the compartment across the direction of the fluid flow.

26. The measuring device according to claim 25, in which the detector electrodes comprise straight electrode strips which are arranged one on top of the other, parallel to the direction of the fluid flow, on the walls of the compartment, wherein the electrode strips comprise different widths, structured edges, or both which are arranged so as to be offset across the direction of the fluid flow.

27. The measuring device according to claim 14, in which at least one further impedance detector, arranged so as to be spaced apart in the direction of the fluid flow, is provided.

28. The measuring device according to claim 14, in which the at least one impedance detector comprises a frequency filter, by means of which frequencies at which the focusing device is operated can be filtered.

29. A method for measuring the impedance in a fluidic microsystem comprising a compartment in which at least one impedance detector is arranged, the method comprising the steps of:
flowing a fluid comprising at least one suspended particle through the compartment,
focusing the particle to a predetermined space relative to the impedance detector, wherein said focusing involves a movement of the particle relative to the fluid as a result of dielectrophoretic forces being exerted by means of at least two focusing electrodes, and
measuring at least one impedance value which is characteristic for the impedance of the compartment and which in the presence of the particle changes in a predetermined way.
